(19) United States
(12) Patent Application Publication
(10) Pub. No.: US 2018/0341710 A1
(43) Pub. Date: Nov. 29, 2018

(54) HETEROGENEOUS SOCIAL NETWORKING

(71) Applicant: MICROSOFT TECHNOLOGY LICENSING, LLC, Redmond, WA (US)

(72) Inventors: Jisheng LIANG, Bellevue, WA (US); Shan YANG, Bellevue, WA (US); Kristine JONES, Seattle, WA (US); Qiang LI, Redmond, WA (US); Xiaoguang QI, Bellevue, WA (US)

(21) Appl. No.: 15/603,818

(22) Filed: May 24, 2017

(51) Int. Cl. G06F 17/30

(52) U.S. Cl. CPC G06F 17/30867; G06Q 50/01; G06F 17/3053

(57) ABSTRACT

Aspects of the technology described here provide systems, methods, computer-storage media, and the like, for identifying one or more influential users. A confidence level is associated with users based on one or more validation metrics. An influence ability score is computed based on weighted values indicated a number of connections and strength of the connections. The confidence level and the influence ability score are then utilized to compute an overall influential score used to rank users according to influence.

### BACKGROUND

Connections among users and/or user influence are typically identified based on explicit user feedback. Previous approaches rely on an explicit social network in which users are connected by one or a few clearly defined relationship types. Such networks require users' explicit input and often do not actually reflect the connection or the flow of influence.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Aspects of the technology described herein identify influential users within social networks. In social network environments, the influence of a user is defined as the user's power to impact other users' opinions or behaviors (e.g., purchase decisions on certain products). Computation of user influence is an important component in many business application scenarios including, but not limited to, targeted marketing, product recommendations, etc. As mentioned, prior approaches relied on explicit social networks where users are connected by one (or a few) clearly defined relationship types. Such networks require users' explicit input and often do not actually reflect the connection or the flow of the influence.

Embodiments provided herein allow for deriving multiple types of connections (or relationships) implicitly from user behavior. Embodiments provided herein also provide for construction of heterogeneous social networks where influence among users is estimated based on real-world feedback. The social network described herein is constructed from both explicit and implicit connections among users. Unlike previous approaches, the present technology derives connections from user behavior data without a user intentionally telling the system. Since the users in this network are connected by different types of relationships, instead of consolidating the relationships, the system preserves the heterogeneous nature of the network and uses pseudo-feedback to gauge the influence flow. Intuitively, the influence flow is different through different types of connections. More specifically, the system uses a correlation between the connection type and the common behavior (e.g., a common product adoption) to estimate the weight of each connection type. This outcome provides more accurate estimates of user influence.

### BRIEF DESCRIPTION OF THE DRAWINGS

Aspects of the disclosure are described in detail below with reference to the attached drawing figures, wherein:

FIG. 1 is a diagram of an exemplary operating environment suitable for implementations of the present disclosure;

FIGS. 2a-2c depict exemplary relationship graphs, in accordance with aspects of the present disclosure;

FIG. 3 depicts a flow diagram of a method for identifying influential users, in accordance with aspects of the present disclosure;

FIG. 4 depicts a flow diagram of a method for identifying influential users, in accordance with aspects of the present disclosure; and

FIG. 5 is a block diagram of an exemplary computing environment suitable for use in implementing an aspect of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

A user's influence is a valuable metric to track in, for example, marketing and social networking environments. An influence of a user may be defined as user's power to impact other users' opinions or behaviors (e.g., purchase decisions on certain products). This information may be valuable as related to, for instance, targeted marketing, product recommendations, etc. This influence may be computed based on social networks that reflect connections or relationships among users.

As mentioned, prior approaches relied on explicit social networks where users are connected by one (or a few) clearly defined relationship types. Such networks require users' explicit input and often do not actually reflect the connection or the flow of the influence. Additionally, prior approaches relied on data that was not necessarily an accurate portrayal of a user's influence. For instance, prior approaches may identify a user as influential based on a number of connections that user has to others. A mere connection to a large number of other users does not accurately reflect the influence of a user since there are no actual measurements on any user behaviors or any validation of influential status.

In one aspect, a method is provided for identifying influential users. The claim recites, identifying one or more implicit connections associated with a first user, wherein an implicit connection is a connection identified without explicit user input; associating a confidence level with the first user based on one or more validation metrics; calculating an influence ability score, wherein the influence ability score is a weighted value representing a number of connections of the first user and a strength of each of the connections; calculating an overall influential score by multiplying the confidence level by the influence ability score; ranking the first user among one or more other users using the overall influential score; and using the rankings, generating personalized content for the first user.

In another aspect, one or more computer storage media are provided having computer-executable instructions embodied thereon, which, when executed by a computing device, cause the computing device to perform a method of identifying influential users. The claim recites, identifying one or more implicit connections associated with a first user, wherein an implicit connection is a connection identified without explicit user input; associating a confidence level with the first user based on one or more validation metrics; calculating an influence ability score, wherein the influence ability score is a weighted value representing a number of connections of the first user and a strength of each of the connections; calculating an overall influential score by multiplying the confidence level by the influence ability score; ranking the first user among one or more other users using the overall influential score; and using the rankings, generating personalized content for the first user.

In yet another aspect, a computer-implemented method is provided for identifying influential users. The claim recites, one or more processors; and one or more computer storage media storing computer-executable instructions. When executed by the one or more processors, the computer-executable instructions are configured to implement a method comprising: identifying one or more implicit connections associated with a first user, wherein an implicit connection is a connection identified without explicit user input; associating a confidence level with the first user based on one or more validation metrics; calculating an influence ability score, wherein the influence ability score is a weighted value representing a number of connections of the first user and a strength of the number of connections; aggregating each influence ability score for each connection of the first user; calculating an overall influential score by multiplying the confidence level by the influence ability score; ranking the first user among a one or more other users using the overall influential score; and using the rankings, generating personalized content for the first user.

A heterogeneous social network is described herein to solve some of the aforementioned limitations of traditional social networking technologies. The heterogeneous social network described herein may include a plurality of types of connections. Connections may be either explicit or implicit. An explicit connection, as used herein, refers generally to a connection identified based on explicit user input (e.g., a user action). An implicit connection, as used herein, refers generally to a connection inferred by the system described herein without explicit user input regarding the connection. Exemplary implicit connections may include, but are not limited to, a shared payment instrument, a shared shipping/billing address, a shared alternative email address, a shared device, a shared subscription, sending an email to another user, playing an online game together, etc. In contrast, exemplary explicit connections may include, but are not limited to, adding another as a friend, following someone, adding someone as a favorite, etc.

The system described herein does not need to identify the type of connection. Rather, the system can identify that one connection is of the same type as another or different than another connection without actually knowing the types of connections. Thus, the present system may be utilized with any type of connection and is not limited to the types described herein. As the system described herein focuses on validation rather than types of connections, the type is not necessary to be known to the system.

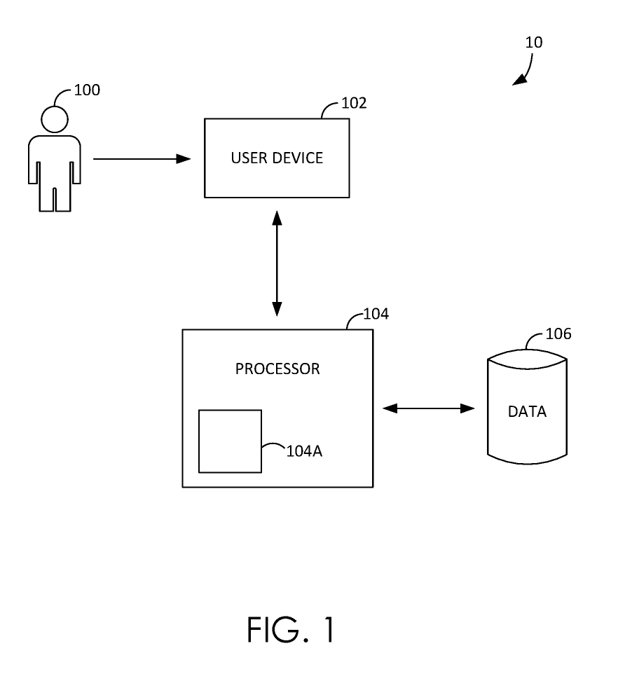

Turning now to FIG. 1, a block diagram is provided showing an exemplary operating environment 10 in which some aspects of the present disclosure may be employed. In operating environment 10, user device 102 and processor 104 are communicatively coupled with each other. These components may communicate with each other via networking means which may include, without limitation, one or more local area networks (LANs) and/or wide area networks (WANs). In exemplary implementations, such networks comprise the Internet and/or cellular networks, amongst any of a variety of possible public and/or private networks.

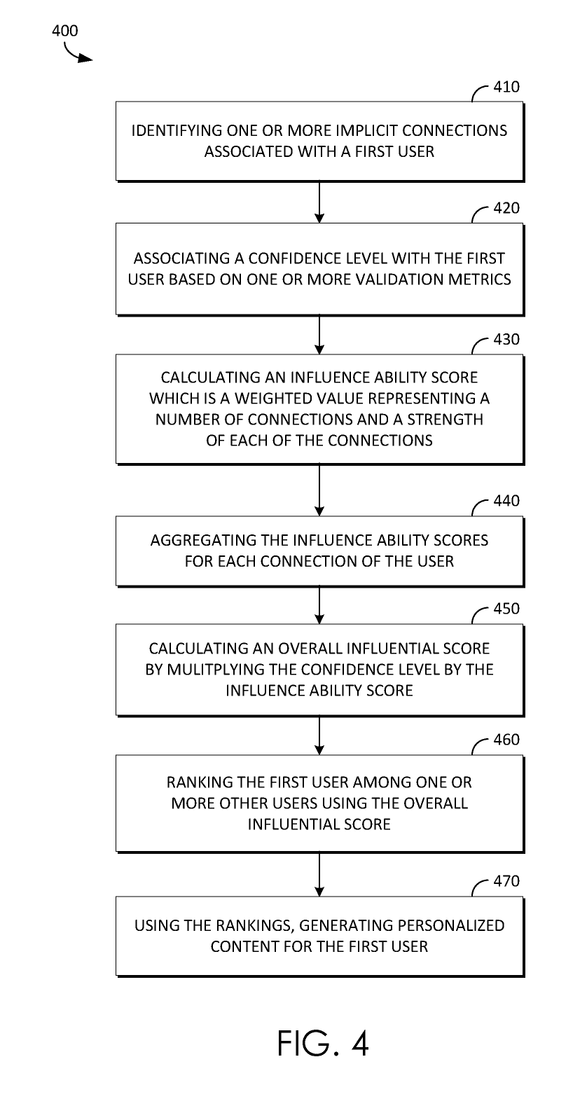

User device 102 may comprise any type of computing device capable of use by a user. For example, in one aspect, user device 102 may be the type of computing device described in relation to FIG. 4 herein. By way of example and not limitation, a user device may be embodied as a personal computer (PC), a laptop computer, a device, a smartphone, a tablet computer, a smart watch, a wearable computer, a fitness tracker, a virtual reality headset, augmented reality glasses, a personal digital assistant (PDA) device, a global positioning system (GPS) or device, a video player, a handheld communications device, a gaming device or system, an entertainment system, a vehicle computer system, an embedded system controller, a camera, a remote control, an appliance, a consumer electronic device, a workstation, or any combination of these delineated devices, a combination of these devices, or any other suitable computer device.

The user device 102 may be equipped with an agent, for example, embodied as a specially designed hardware for identifying influence of users, a browser plug-in, a specially designed computer program or application operating on a user device, across multiple devices, or in the cloud, for identifying influence of users, or a computing service running in the cloud to implement one or more of the technical solutions discussed herein for identifying influence of users.

In one aspect, the agent or any other component within the user device 102 works in synergy with the processor 104 to enable identification of influential users by sending and/or receiving information from the processor 104 as well as executing instructions provided by the processor 104.

The processor 104 can enable identification of influential users. In some embodiments, the processor could be a stand-alone server device. In other embodiments, the processor 104 may be implemented as services in a computing cloud. The processor 104 may include various components for generation of the heterogeneous social network described herein and generation of instructions based on the heterogeneous social network.

Processor 104 may include a connection handler, a confidence level handler, a calculator, a ranker, a generator, etc. Additionally, processor 104 may comprise a data store or be in communication with a separate data store such as data store 106.

As mentioned above, the present system 10 does not need to identify a type of connection between users. The system 10 can identify that connections are the same or different without identifying the specific type of connection. The system 10 can identify explicit connections, implicit connections, or a combination thereof. A connection handler, for instance, may be configured to identify explicit connections, implicit connections, and the like. The connection handler can derive multiple types of connections (or relationships) implicitly from user behavior and construct a heterogeneous social network with estimated influence.

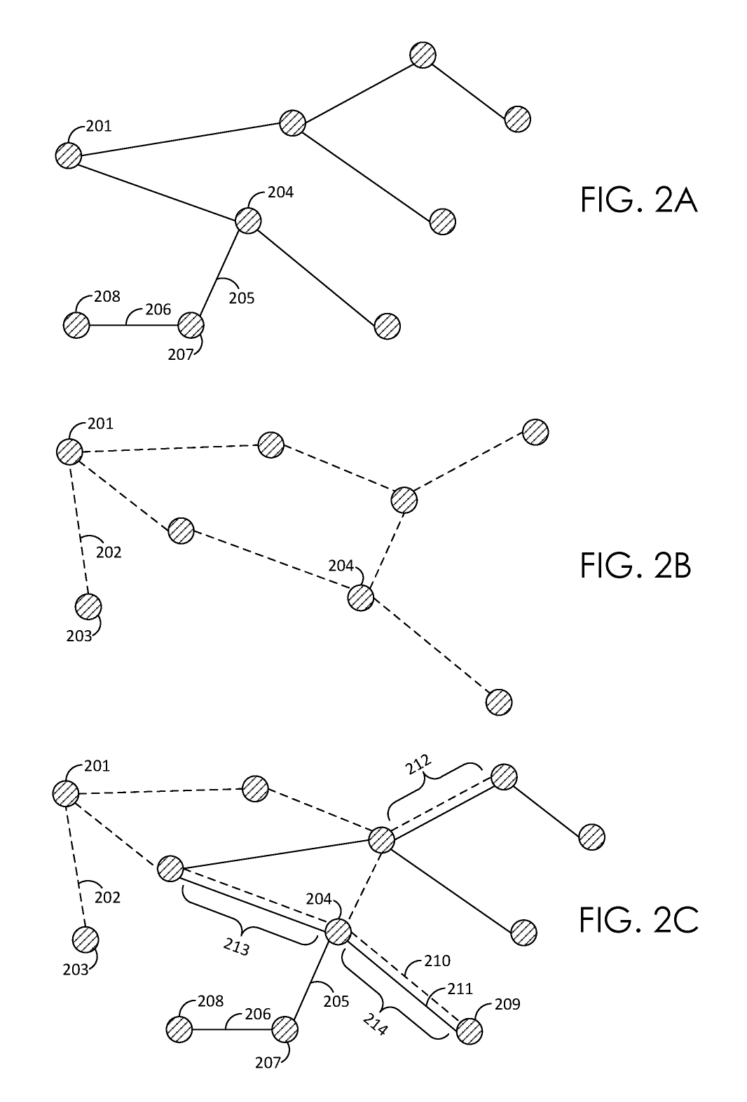

An exemplary heterogeneous network is depicted in FIGS. 2a-2c. Different types of connections are illustrated in FIGS. 2a and 2b. For instance, a first type of connection (e.g., “send email” connection) is shown in FIG. 2a and a second type of connection (“Xbox friend” connection) is shown in FIG. 2b. Each node represents a user and, as such, the terms may be used interchangeably herein. So, for instance, in FIG. 2a, node 201, node 204, node 207, and node 208 each represent a different user. The connections between users are represented by edges. For example, edge 205 is a connection between user 204 and user 207 while edge 206 is a connection between user 207 and user 208. Similarly, edge 202 represents a connection between user 201 and user 203 in FIG. 2b.

When only one connection is considered, the social graph looks like the graph depicted in either FIG. 2a or FIG. 2b. When the connections are jointly considered (can be any number of connections even though only shown as two here) the graph will look like that depicted in FIG. 2c. Some users are connected by both the first connection type and the second connection type, such as users 204 and 209. Using feedback or a validation metric(s), a confidence of an edge may be computed and used as a weight when the system 10 propagates the influence along the edges. Therefore, in the combined graph shown in FIG. 2c, the edges with both types of connections between users will carry more weight (and, thus, more influence) along them that others. Put simply, connections 212, 213 and 214 will be weighted more heavily than connection 205, 206 or connection 202.

The influence values discussed above with respect to the social network may be identified and/or computed by one or more of a confidence level handler, a calculator, or any other component or instruction configured to compute influence values as described herein. In particular, an overall influential score is computed to identify users having a large influence over other users or the behavior of other users. The overall influential score may be computed using a confidence level and an influence ability score.

A confidence level may be assigned to a user based on validation metrics. Validation metrics may comprise product adoptions or any additional user behaviors that may be attributed to another user. A validation metric may be referred to as any user behavior that is within a predetermined period of time from the same behavior from a different user.

An exemplary validation metric may be, as mentioned, a product adoption. For example, if User A is connected with User B and shortly after User A purchases Product X then User B purchases Product X, the product adoption by User B may be attributed to User A's influence. This is merely one example of how a behavior of a user connected to others is evaluated.

An influence ability score represents how many connections a user has and how strong they are. Thus, a number of connections for a particular user may be identified along with a weight of the connection. In particular, the influence ability score in computed by identifying an importance score for the user that represents the importance of pages or links to the user and by weighting the connections of the user based on a count of users associated with the connection and the interaction with the connection. Once weighted, the weighted importance scores may be aggregated to identify the influence ability score. Each connection may have a different importance score.

Once aggregated, the influence ability scores are multiplied by the confidence level to identify the overall influential score for the user. The calculation is shown below:

Confidence level×Influence Ability Score=Overall Influential Score

The overall influential scores may be utilizing among users by, for instance, a ranker, to rank multiple users according to influence. The ranking may, in turn, be used to generate personalized content for influential users (by, for instance, a generator). For example, if a user is ranked very high as far as influence, the user may be identified as a target for particular content to either invoke an action in the user that may be mimicked by others or to increase a likelihood that others connected to that user will see the content as well.

Since users in the heterogeneous network are connected by different types of relationships, instead of consolidating the relationships, the system 10 preserves the heterogeneous nature of the network and uses pseudo-feedback to gauge the influence flow. Intuitively, the influence flow is different through different types of connections. More specifically, the correlation between the connection type and a validation metric (e.g., product adoption) is used to estimate the weight of each connection type.

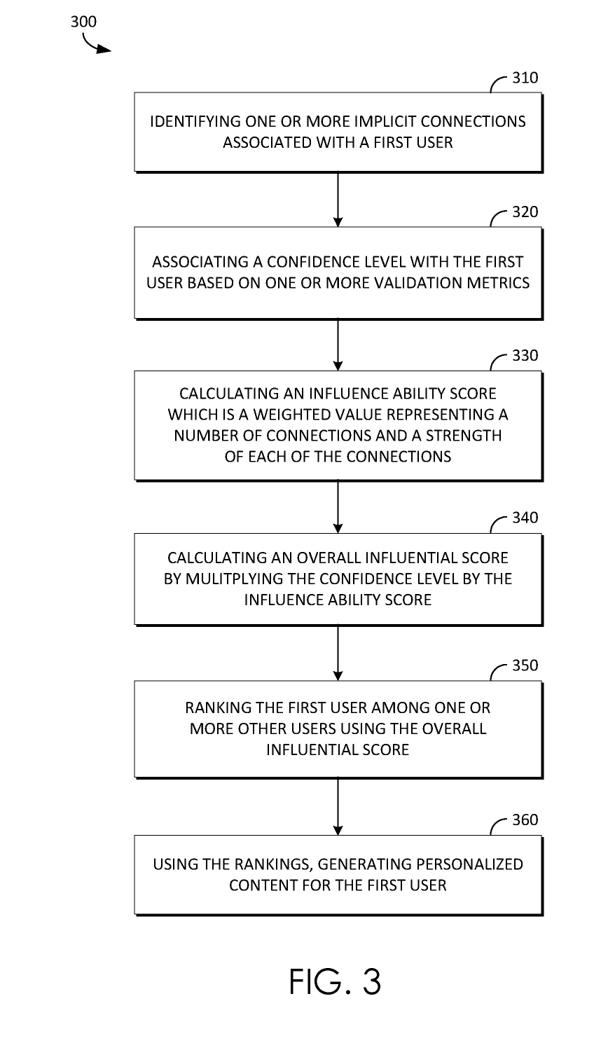

FIG. 3 depicts a flow diagram of a method 300 for identifying influential users, in accordance with an aspect of the present disclosure. Initially, at block 310, one or more implicit connections associated with a user are identified. A confidence level is associated with a user based on one or more validation metrics at block 320. At block 330, an influence ability score is calculated. The influence ability score is a weighted value representing a number of connections and a strength of each of the connections. An overall influential score is calculated by multiplying the confidence level by the influence ability score at block 340. The first user is then ranked among one or more other users using the overall influential score at block 350. Using the rankings, personalized content for the first user is generated at block 360.

FIG. 4 depicts a flow diagram of a method 400 for identifying influential users, in accordance with an aspect of the present disclosure. Initially, at block 410, one or more implicit connections associated with a first user is identified. A confidence level is associated with the first user based on one or more validation metrics at block 420. An influence ability score is calculated at block 430. The influence ability score is a weighted value that represents a number of connections and a strength of each of the connections. The influence ability scores are aggregated for each connection of the user at block 440. At block 450, an overall influential score is calculated by multiplying the confidence level by the influence ability score. The first user is then ranked among one or more other users using the overall influential score at block 460. At block 470, personalized content is generated for the first user using the rankings identified at block 460.

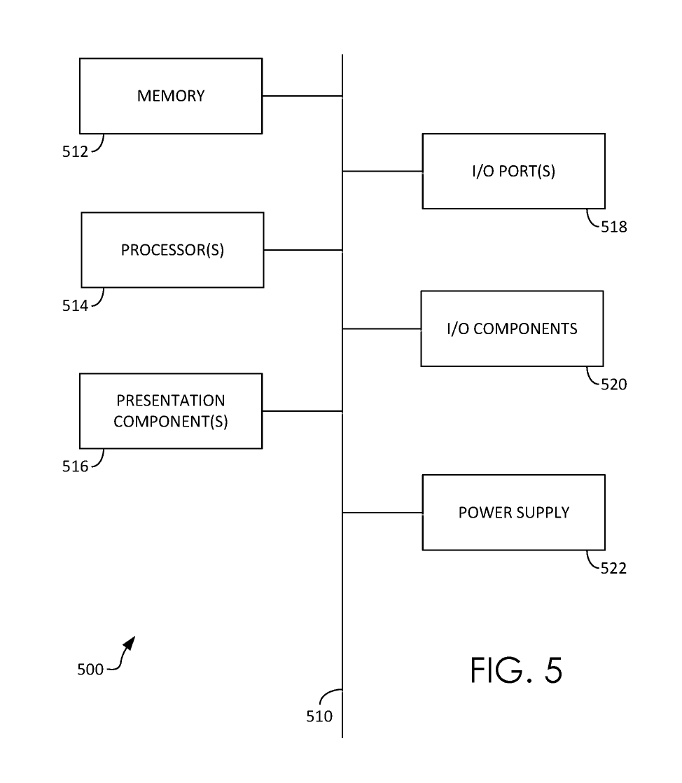

Having described various implementations, an exemplary computing environment suitable for implementing aspects of the disclosure is now described. With reference to FIG. 5, an exemplary computing device is provided and referred to generally as computing device 500. The computing device 500 is but one example of a suitable computing environment and is not intended to suggest any limitation as to the scope of use or functionality of aspects of the disclosure. Neither should the computing device 500 be interpreted as having any dependency or requirement relating to any one or combination of components illustrated.

Aspects of the disclosure may be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Aspects of the disclosure may be practiced in a variety of system configurations, including handheld devices, consumer electronics, general-purpose computers, more specialty computing devices, etc. Aspects of the disclosure may also be practiced in distributed computing environments where tasks are performed by remote-processing devices that are linked through a communications network. In a distributed computing environment, program modules may be located in both local and remote computer storage media including memory storage devices.

With reference to FIG. 5, computing device 500 includes a bus 510 that directly or indirectly couples the following devices: memory 512, one or more processors 514, one or more presentation components 516, one or more input/output (I/O) ports 518, one or more I/O components 520, and an illustrative power supply 522. Bus 510 represents what may be one or more busses (such as an address bus, data bus, or combination thereof). Although the various blocks of FIG. 5 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 5 is merely illustrative of an exemplary computing device that can be used in connection with one or more aspects of the present disclosure. Distinction is not made between such categories as “workstation,” “server,” “laptop,” “handheld device,” etc., as all are contemplated within the scope of FIG. 5 and with reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 512 includes computer storage media in the form of volatile and/or nonvolatile memory. The memory may be removable, non-removable, or a combination thereof. Exemplary hardware devices include solid-state memory, hard drives, optical-disc drives, etc. Computing device 500 includes one or more processors 514 that read data from various entities such as memory 512 or I/O components 520. Presentation component(s) 516 presents data indications to a user or other device. Exemplary presentation components include a display device, speaker, printing component, vibrating component, and the like.

The I/O ports 518 allow computing device 500 to be logically coupled to other devices, including I/O components 520, some of which may be built in. Illustrative components include a microphone, joystick, game pad, satellite dish, scanner, printer, wireless device, etc. The I/O components 520 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 500. The computing device 500 may be equipped with depth cameras, such as stereoscopic camera systems, infrared camera systems, RGB camera systems, and combinations of these, for gesture detection and recognition. Additionally, the computing device 500 may be equipped with accelerometers or gyroscopes that enable detection of motion. The output of the accelerometers or gyroscopes may be provided to the display of the computing device 500 to render immersive augmented reality or virtual reality.

Computing device 500 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Aspects of the disclosure have been described with the intent to be illustrative rather than restrictive. Alternative aspects will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A computer-implemented method of identifying one or more influential users, the method comprising:
identifying one or more implicit connections associated with a first user, wherein an implicit connection is a connection identified without explicit user input;
associating a confidence level with the first user based on one or more validation metrics;
calculating an influence ability score, wherein the influence ability score is a weighted value representing a number of connections of the first user and a strength of each of the connections;
calculating an overall influential score by multiplying the confidence level by the influence ability score;
ranking the first user among one or more other users using the overall influential score; and
using the rankings, generating personalized content for the first user.

2. The method of claim 1, wherein a validation metric is a product adoption.

3. The method of claim 1, wherein a validation metric is one or more behaviors of at least one of the one or more other users implicitly connected to the user.

4. The method of claim 1, further comprising generating personalized content for the one or more other users.

5. The method of claim 1, further comprising identifying one or more explicit connections associated with the first user.

6. The method of claim 5, wherein both the one or more implicit connections and the one or more explicit connections are utilized when ranking the first user.

7. The method of claim 1, wherein at least one of the implicit connections is a shared payment method between the first user and a second user.

8. The method of claim 1, wherein at least one of the implicit connections is a shared device between the first user and a second user.

9. One or more computer storage media having computer-executable instructions embodied thereon, which, when executed by a computing device, cause the computing device to perform a method of identifying one or more influential users, the method comprising:
identifying one or more implicit connections associated with a first user, wherein an implicit connection is a connection identified without explicit user input;
associating a confidence level with the first user based on one or more validation metrics;
calculating an influence ability score, wherein the influence ability score is a weighted value representing a number of connections of the first user and a strength of each of the connections;
calculating an overall influential score by multiplying the confidence level by the influence ability score;
ranking the first user among one or more other users using the overall influential score; and
using the rankings, generating personalized content for the first user.

10. The media of claim 9, wherein a validation metric is a product adoption.

11. The media of claim 9, wherein a validation metric is one or more behaviors of at least one of the one or more other users implicitly connected to the user.

12. The media of claim 9, further comprising generating personalized content for the one or more other users.

13. The media of claim 9, further comprising identifying one or more explicit connections associated with the first user.

14. The media of claim 13, wherein both the one or more implicit connections and the one or more explicit connections are utilized when ranking the first user.

15. The media of claim 9, wherein at least one of the implicit connections is a shared payment method between the first user and a second user.

16. The media of claim 9, wherein at least one of the implicit connections is a shared device between the first user and a second user. .

17. A computer system comprising:
one or more processors; and
one or more computer storage media storing computer-executable instructions that, when executed by the one or more processors, are configured to implement a method comprising:
identifying one or more implicit connections associated with a first user, wherein an implicit connection is a connection identified without explicit user input;
associating a confidence level with the first user based on one or more validation metrics;
calculating an influence ability score, wherein the influence ability score is a weighted value representing a number of connections of the first user and a strength of the number of connections;
aggregating each influence ability score for each connection of the first user;
calculating an overall influential score by multiplying the confidence level by the influence ability score;
ranking the first user among a one or more other users using the overall influential score; and
using the rankings, generating personalized content for the first user.

18. The system of claim 17, wherein the method further comprises generating personalized content for each of the first user and the one or more other users.

19. The system of claim 17, wherein the method further comprises
identifying one or more explicit connections associated with the first user; and
utilizing both the one or more explicit connections and the one or more implicit connections when ranking.

20. The system of claim 17, wherein a validation metric is a product adoption
